(19) United States
(12) Patent Application Publication
(10) Pub. No.: US 2005/0014928 A1
(43) Pub. Date: Jan. 20, 2005

(54) Epoxy resin polymer and alignment film materials containing same for liquid crystal display

(75) Inventors: Wen -Chung Chu, Chiautou Shiang (TW); Chia-Wen Chang, Taichung City (TW); Hai-Feng Yu, Qinhuangdao City (CN); Yen-Ching Lien, Beijing City (CN); Hsiao-Kung Wang, Beijing City (CN); Te-Shan Liu, Beijing City (CN)

Correspondence Address: SCULLY SCOTT MURPHY & PRESSER, PC, 400 GARDEN CITY PLAZA, GARDEN CITY, NY, 11530, US

(73) Assignee: Eternal Chemical Co., Ltd., Kaohsiung (TW)

(21) Appl. No.: 10/849,953

(22) Filed: May 20, 2004

(30) Foreign Application Priority Data
May 20, 2003 (TW) 092113611

(51) Int. Cl. C08G 59/00

(52) U.S. Cl. 528/403

(57) ABSTRACT

The invention pertains to a polymer of formula (I): 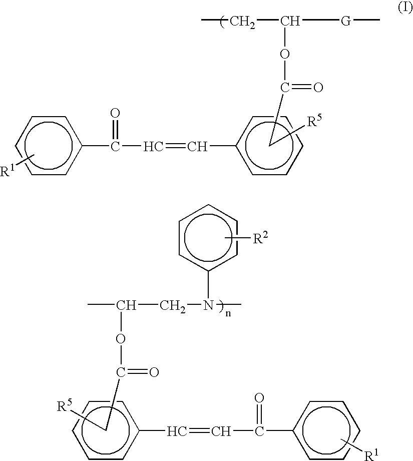
wherein R¹, R², R⁵, n and G arc as those defined in the specification. The invention also pertains to the preparation of the polymer and the use of the polymer as an alignment layer material in liquid crystal displays.

### BACKGROUND OF THE INVENTION

1. Field of the Invention

The present invention relates to an alignment film material for use in liquid crystal displays to allow the liquid crystal molecules to be orientated stably and uniformly.

2. Description of the Prior Art

Alignment technique is one of the main techniques for determining the quality of liquid crystal displays (LCDs). Alignment technique will directly affect the quality of the final liquid crystal display (LCD) elements. High quality LCDs require a stable and uniform initial orientation of liquid crystal molecules, and the film for inducing the orientation is called an LCD alignment film.

Currently known materials for use in alignment films include polystyrene and the derivatives thereof, polyimide, polyvinyl alcohol, polyester, epoxy resin, polyurethane, polysiloxane, and the like, of which polyimide is most commonly used as an alignment film material. These materials may align liquid crystal molecules by a rubbed film (rubbing method), an obliquely evaporated SiOx film, or a micro-groove treated film.

Among the various LCD alignment methods, the rubbing method has been most widely utilized in the production of LCDs because it is simply and convenient. This method normally comprises pressing a substrate onto a consistently moving rubbing cloth and achieving the alignment by rubbing. The rubbing method also may comprise using a rubbing roll coated with silk cloth to result in micro-grooves, which can be seen under an electronic microscope, on the substrate, and to allow liquid crystal molecules to be aligned parallel to or oblique to the groove directions on the surface of the grooves and to be orientated. However, there are a number of disadvantages normally associated with the rubbing method. First, rubbing will produce dust and affect the quality of LCDs. Secondly, rubbing will produce an electrostatic charge which can result in destruction of thin film transistors and reduce the production yield. Moreover, since rubbing is only useful for a flat surface and not practical for a curved surface, rubbing methods cannot satisfy the demand in current market.

Recently, Schadt et al disclosed an LCD alignment technique involving linearly polarized photo-polymerization. This technique comprises irradiating polyvinyl cinnamate with linearly polarized light; to cross-link the double bond in the polyvinyl cinnamate so as to render the polymer anisotropic. The molecular bonds, originally, are randomly arranged on the surface of a substrate, and will be subjected to an anisotropic reaction when exposing to polarized ultra-violet light. The resultant polymeric film is effective in aligning liquid crystals and is called a photo-aligzunent layer. Such an advanced LCD alignment technique is called LCD photo-alignment method.

LCD photo-alignment method is a non-contact, surface treatment method, which applies linearly polarized polymerization technique to the production of LCDs and avoids the drawbacks associated with the rubbing method. Such method can allow the production of display elements to be more simple and convenient, and increase the production yield and reduce the production cost. Consequently, there is a bright practical outlook for LCD photo-alignment method in the production of high quality LCDs, particularly, large screen displays, and the alignment layer for liquid crystals is crucial to the practice of the method. The inventors of the present invention have found that the epoxy resin polymer having chalcone in the side chain of the polymer can be used as the material for LCD alignment layer.

### DESCRIPTION of the INVENTION

One of the objects of the invention is to provide an epoxy resin polymer and the preparation thereof.

Another object of the present invention is to provide a material for an LCD alignment layer containing said epoxy resin polymer.

The epoxy resin polymer of the invention has the structure of formula (I): 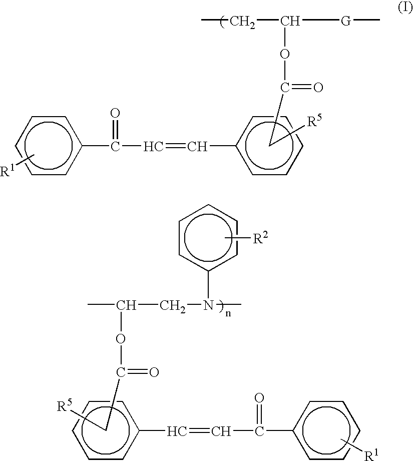
wherein:
n is an integer greater than 1;
R¹ and R² are independently hydrogen, halogen, nitro, C₁₋₁₆ alkyl, or C₁₋₁₆ alkoxy, and are independently at the ortho-, meta-, or para-position at the benzene rings;
R⁵ is hydrogen, C₁₋₁₀ alkyl, or C₁₋₁₀ alkoxy, and is at the ortho-, meta, or para-position at the benzene ring;
G is selected from the group consisting of:
(1) glycidyl ethers;
   —CH₂—O—R—O—CH₂—
   wherein R is selected from the group consisting of:
(a) a radical derived from hydroquinone 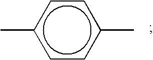
(b) a radical derived from diphenol 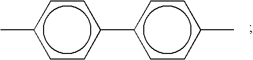
(c) a radical derived from bisphenol F 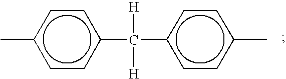
(d) a radical derived from bisphenol S 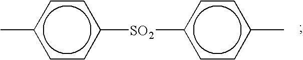
(e) a radical derived from hydrogenated bisphenol A 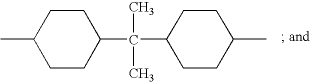
(f) a radical derived from a halo compound 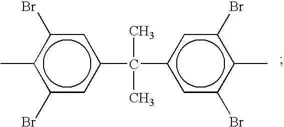
(2) glycidyl amines: 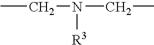
   wherein R³ is C₁₋₁₆ alkyl;
(3) glycidyl ester: 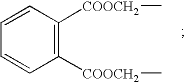
(4) glycerol: 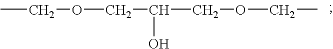
(5) ethylene glycol:
   —CH₂—O—CH₂—CH₂—O—CH₂—;
(6) organic silicon: 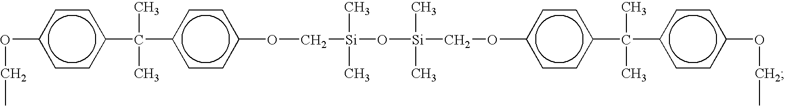
(7) alicyclic: 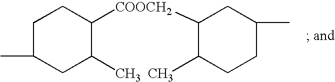
(8) imide epoxy resins: 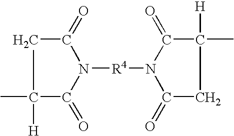
   wherein R⁴ is aryl.

According to the invention, the R⁴ in the above imide epoxy resin together with the two nitrogens to which it attaches is derived from an aromatic diamine. Suitable aromatic diamines for the invention are obvious to persons skilled in the art, which may include those described in U.S. Pat. No. 4,954,612, the contents of which are incorporated herei for serving as a further illustration of said aromatic diamines.

According to one of the preferred embodiments of the invention, in formula (I), n is an integer of 1 to 300; R¹ is hydrogen, C₁₋₆ alkyl, C₁₋₆ alkoxy, or halogen, and more preferably is selected from the group consisting of ortho-methyl, meta-ethyl, para-methoxy, and para-chloro; R² is hydrogen, C₁₋₆ alkyl, C₁₋₆ alkoxy, or halogen, and more preferably is selected from the group consisting of hydrogen, ortho-methyl, meta-ethyl, para-methoxy, and para-chloro; and R⁵ is hydrogen, C₁₋₆ alkyl, or C₁₋₆ , alkoxy. According to another preferred embodiment of the invention, in formula (I), R⁵ is at the meta- or ortho-position relative to the —HC═CH— group, and the —C═O group is at the para-position relative to the —HC═CH— group.

The invention also provides a process for preparing the epoxy resin polymer of formula (I), comprising
(A) conducting a condensation polymerization of an epoxy resin monomer and an aniline monomer at a temperature from 50 to 10° C. to produce a hydroxy-containing pre-polymer, wherein the epoxy resin monomer is selected from the group consisting of:
(1) glycidyl ethers: 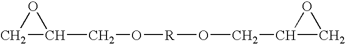
   wherein R is selected from the group consisting of;
(a) a radical derived from hydroquinone: 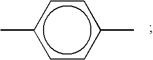
(b) a radical derived from diphenol: 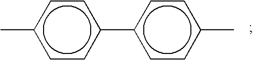
(c) a radical derived from bisphenol F 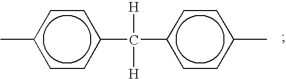
(d) a radical derived from bisphenol S 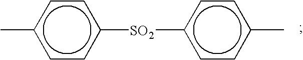
(e) a radical derived from hydrogenated bisphenol A: 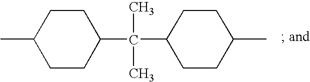
(g) a radical derived from a halo compound: 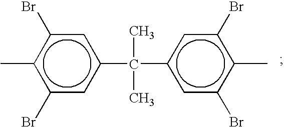
(2) glycidyl amines: 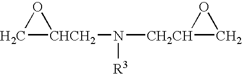
   wherein R³ is defined as hereinabove;
(3) glycidyl ester: 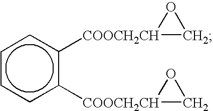
(4) glycerol: 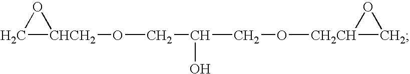
(5) ethylene glycol: 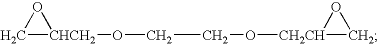
(6) organic silicon: 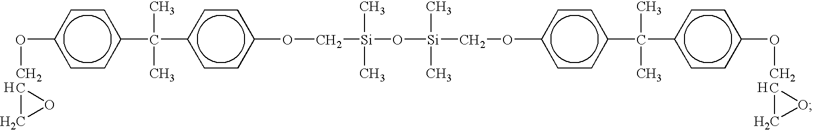
(7) alicyclic: 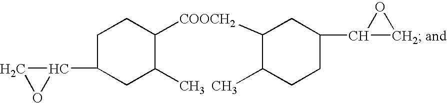
(8) imide epoxy resin: 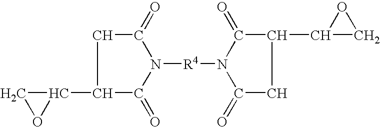
   wherein R⁴ is defined as hereinabove; and
wherein the aniline monomer is selected from the compounds of formula (II): 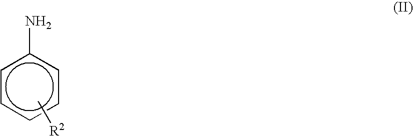
   wherein R² is hydrogen, halogen, nitro, C₁₋₁₆ ally, or C₁₋₁₆ alkoxy, and is at the orth-, meta-, or para-position of the benzene ring; and
(B) adding a chalcone acyl halide monomer, a solvent, and optional an acid absorber to the pre-polymer obtained in step (A) and controlling the temperature between 30 to 100° C. to obtain the polymer of formula (I), wherein said chalcone acyl halide monomer is selected from the compounds of formula (III): 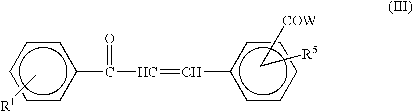
   wherein R¹ is hydrogen, halogen, nitro, C₁₋₁₆ alkyl, or C₁₋₁₆ alkoxy; R⁵ is hydrogen, C₁₋₁₀ alkyl, or C₁₋₁₀ alkoxy; W is halogen; and R¹, R⁵, and COW are at the ortho-, meta-, or para-position of the benzene rings.

Suitable aniline monomers of formula (II) used in Step (A) are those in which R² is hydrogen, C₁₋₁₆ alkyl, C₁₋₁₆ alkoxy, or halogen.

Suitable aniline monomers of formula (II) for the invention include, but are not limited to, aniline, ortho-methylaniline, meta-ethylaniline, para-methoxyaniline, or para-chloroaniline.

Suitable chalcone acyl halide monomers of formula (III) for the invention include, for example, chalcone acyl chloride in which R¹ is hydrogen, C¹⁻⁶ alkyl, C₁₋₆ alkoxy, or halogen; and R⁵ is hydrogen, C₁₋₆ alkyl, or C₁₋₆ alkoxy. According to one of the preferred embodiments of the invention, the radical COW of formula (III) is at the para-position of the benzene ring. The chalcone acyl halide monomers useful in the invention include, for example, but are not limited to, chalcone acyl chloride, ortho-methyl chalcone acyl chloride, meta-ethyl chalcone acyl chloride, para-methoxy chalcone acyl chloride, and para-chlorochalcone acyl chloride.

The solvent used in the above reaction is normally an aprotic polar. solvent. Useful solvent for the reaction is preferably selected from the group consisting of tetrahydrofuran (THF), N,N-dimethylforamide (DMF), dimethyl sulfoxide (DMSO), N,N-dimethylacetamide (DMAC), and N-methylpyrrolidone (NMP), and a mixture thereof.

The acid absorber optionally used in the above reaction is normally a base reactive with an acid, which preferably is selected from the group consisting of pyridine (Py), triethylamine (TEA), N-ethylmorpholine (NEM), and dimethylaniline (DMAN), and a mixture thereof.

When used herein, the term “halogen” represents fluorine, chlorine, bromine, or iodine, preferably chlorine or bromine, and most preferably chlorine.

The epoxy resin polymer of the invention has an average molecular weight of about 5,000 to 200,000. Depending on the polymerization conditions, the branching level of the polymer may range from 40% to 100%.

The epoxy resin polymer of the invention can be used in an LCD alignment layer material by any of the conventional methods. For instance, the epoxy resin polymer of the invention can be dissolved in an aprotic solvent to form a homogeneous solution with a certain concentration. This solution is then deposited onto a substrate by spin coating. The coated substrate is exposed to a polarized ultra-violet light (e.g., that having a wavelength of 365 nm) to induce a (2+2) cyclization of the double bond of the chalcone group in the branched chains so as to render the polymer anisotropic and induce the orientation of liquid crystal molecules. The photo-alignment layer can be utilized in the assembly of liquid crystal elements for twisted nametic, supertwisted nametic, and film transistor LCDs.

The present invention will be further described in the following examples. However, the examples will not make any limitations to the scope of the invention. Any modifications or alterations on the invention that can be easily accomplished by persons skilled in the art are encompassed in the disclosure of the specification and the accompanying claims.

### EXAMPLES

### Example 1

Synthesis of Pre-Polymer of Bisphenol F Glycidyl Ether Epoxy Resin-Aniline

To a flask equipped with a stirrer, bisphenol F glycidyl ether epoxy resin and aniline were separately added. The feed ratio in terms of the functional groups was 1:1. The mixture was heated to 1° C. and reacted for 48 hours. A light yellow solid cake is obtained. The solid cake was dissolved in a mixture of CH₃OH and CHCl₃. The resultant solution was filtered to remove the insoluble substance. A large amount of acetone was added to the filtrate to precipitate the pre-polymer. A viscous material was obtained. The viscous material was dried in a vacuum oven to obtain a layered solid.

Synthesis of Chalcone Acyl Chloride

Para-carboxy benzaldehyde (9 g, 0.06 mol) and phenyl ethyl ketone (7.2 g, 0.06 mol) were dissolved in 60 ml anhydrous ethanol and stirred continuously. An aqueous 50% KOH solution (16.38 g) was dropwise added to the resultant mixture. The reaction was maintained at room temperature for 12 hours. Upon completion of the reaction, the reaction mixture was poured into an aqueous diluted acid solution, precipitated, washed, filtered, dried at 60° C. and normal pressure, and re-crystallized in ethanol to obtain chalcone carboxylic acid. The chalcone carboxylic acid was added to a suitable amount of dichloro sulfoxide (SOCl₂). The reaction was conducted in a water bath at 40 to 70° C. A white solid was obtained.

Synthesis of Photosensitive Polymer

In a three-necked bottle equipped with a reflux condenser, the pre-polymer obtained above was added and dissolved in anhydrous tetrahydrofuran to obtain a clear solution. A small amount of anhydrous pyridine was added. A solution of chalcone acyl chloride in anhydrous tetrahydrofuran was slowly added to the reaction. The ratio of the functional groups was controlled to be −OH:COCl═1:1.15 to 1:10. The reaction was conducted at 55° C. in a water bath for 12 to 24 hours to obtain a light yellow polymer solution. The polymer solution was slowly added to a methanol solution, precipitated, vacuum-filtered, washed, and dried in a vacuum oven to obtain while powdered solid.

Synthesis of Liquid Crystal Alignment Layer Material

The photosensitive bisphenol F glycidyl ether epoxy resin polymer obtained above was dissolved in DMF. The resultant solution was applied onto a substrate by spin coating and photo-crosslinked by exposure to polarized ultra-violet light (365 nm) for 15 minutes to obtain a liquid crystal alignment layer material.

### Example 2

The steps of Example 1 were repeated except that phenyl ethyl ketone was replaced by methylphenyl ethyl ketone.

### Example 3

The steps of Example 1 were repeated except that phenyl ethyl ketone was replaced by meta-methylphenyl ethyl ketone.

### Example 4

The steps of Example 1 were repeated except that phenyl ethyl ketone was replaced by para-methoxyphenyl ethyl ketone.

### Example 5

The steps of Example 1 were repeated except that phenyl ethyl ketone was replaced by ortho-methoxyphenyl ethyl ketone.

### Example 6

The steps of Example 1 were repeated except that phenyl ethyl ketone was replaced by para-chlorophenyl ethyl ketone.

### Example 7

The steps of Example 1 were repeated except that phenyl ethyl ketone was replaced by para-nitrophenyl ethyl ketone.

### Example 8

The steps of Example 1 were repeated except that phenyl ethyl ketone was replaced by para-ethylphenyl ethyl ketone.

### Example 9

The steps of Example 1 were repeated except that phenyl ethyl ketone was replaced by para-ethoxyphenyl ethyl ketone.

### Example 10

The steps of Example 1 were repeated except that phenyl ethyl ketone was replaced by para-fluorophenyl ethyl ketone.

### Example 11-20

The steps of Examples 1 to 10 were repeated except that the bisphenol F glycidyl ether epoxy resin was replaced by bisphenol S glycidyl ether epoxy resin.

### Example 21-30

The steps of Examples 1 to 10 were repeated except that the bisphenol F glycidyl ether epoxy resin was replaced by diphenol glycidyl ether epoxy resin.

### Example 3140

The steps of Examples 1 to 10 were repeated except that the bisphenol F glycidyl ether epoxy resin was replaced by bisphenol A glycidyl ether epoxy resin.

### Example 41-50

The steps of Examples 1 to 10 were repeated except that the bisphenol F glycidyl ether epoxy resin was replaced by halo glycidyl ether epoxy resin.

### Example 51-60

The steps of Examples 1 to 10 were repeated except that the bisphenol F glycidyl ether epoxy resin was replaced by glycidyl ester epoxy resins. Example 61-70

The steps of Examples 1 to 10 were repeated except that the bisphenol F glycidyl ether epoxy resin was replaced by glycidyl amine epoxy resins.

### Example 71-80

The steps of Examples 1 to 10 were repeated except that the bisphenol F glycidyl ether epoxy resin was replaced by imide epoxy resins.

### Example 81-90

The steps of Examples 1 to 10 were repeated except that the bisphenol F glycidyl ether epoxy resin was replaced by organic silicon epoxy resins.

### Example 91-100

The steps of Examples 1 to 10 were repeated except that the bisphenol F glycidyl ether epoxy resin was replaced by glycerol epoxy resins.

### Example 101-200

The steps of Examples 1 to 100 were repeated except that the aniline was replaced by para-methylaniline.

### Example 201-300

The steps of Examples 1 to 100 were repeated except that the aniline was replaced by para-nitroaniline.

### Example 301-400

The steps of Examples 1 to 100 were repeated except that the aniline was replaced by para-fluoroaniline.

### Example 401-500

The steps of Examples 1 to 100 were repeated except that the aniline was replaced by para-methoxyaniline.

### Example 501-600

The steps of Examples 1 to 100 were repeated except that the aniline was replaced by para-ethylaniline.

### Example 601-700

The steps of Examples 1 to 100 were repeated except that the aniline was replaced by para-ethoxyaniline.

### Example 701-800

The steps of Examples 1 to 100 were repeated except that the aniline was replaced by para-chloroaniline.

### Example 801-900

The steps of Examples 1 to 100 were repeated except that the aniline was replaced by para-cyanoaniline.

### Example 901-1000

The steps of Examples 1 to 100 were repeated except that the aniline was replaced by para-trifluoromethylaniline.

### Example 1001-1100

The steps of Examples 1 to 100 were repeated except that the aniline was replaced by para-butoxyaniline.

Test results

The above pre-polymers and photosensitive polymers produced from various epoxy resin monomers with various aniline monomers by linear condensation polymerization were analyzed by IR spectroscopy, NMR spectroscopy, and DSC to ascertain the actual productions. The resultant polymers have higher molecular weight and a branching level of up to 40 to 100%.

The photosensitive polymers were dissolved in a solvent. The resultant solutions were applied to a substrate by spin coating and photo-crosslinked by exposure to ultra-violet light (260 to 365 nm). It was found that the irradiated polymers were no longer dissolved in any kind of solvents. This showed that the polymers were subjected to crosslinking reaction. A comparison between the IR spectrums of the polymer before and after the irradiation revealed that the C=C absorption peak (˜1630 cm⁻¹) is reduced. This further showed that a crosslinking reaction occurred at the double bond. The DSC data of the irradiated polymers showed that the glass transition temperatures of the polymers disappeared, which further showed that crosslinking reactions did happen.

The photosensitive polymers were formulated into solutions with certain concentrations. The resultant solutons were then applied onto a substrate by spin coating and subjected to photo cross-linking reaction by exposing to a polarized ultra-violet light to produce liquid crystal alignment layers. The alignment layers were assembled into liquid crystal cells by any of conventional techniques (e.g., vacuum technique, capillarity technique, or the like). A liquid crystal material was injected into the cells. The cells were observed by a polarizing microscope. When the cells were rotated, changes in darkness and lightness were clearly observed. This showed that the alignment layers did render the liquid crystals orientated. That is, the polymers of the invention possess the desired properties.

1. A polymer having the structure of formula (I): 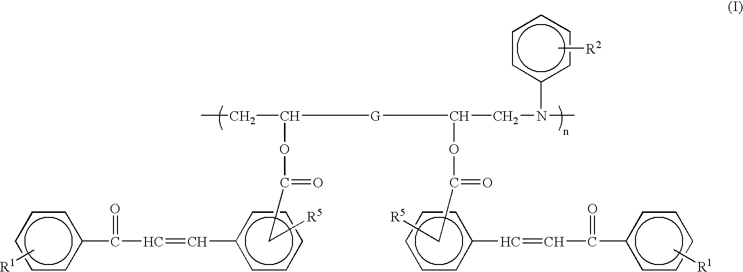
wherein:
n is an integer greater than 1;
R¹ and R² are independently hydrogen, halogen, nitro, C₁₋₁₆ alkyl, or C₁₋₁₆ alkoxy, and are independently at the ortho-, meta-, or pura-position at the benzene rings;
R⁵ is hydrogen, C₁₋₁₀ alkyl, or C₁₋₁₀ alkoxy, and is at the ortho-, meta-, or para-position at the benzene ring;
G is selected from the group consisting of:
(1) glycidyl ethers;
—CH₂—O—R—O—CH₂—
wherein R is selected from the group consisting of
(a) a radical derived from hydroquinone 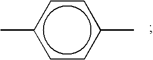
(b) a radical derived from diphenol 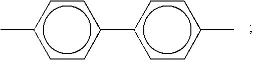
(c) a radical derived from bisphenol F 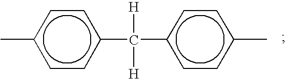
(d) a radical derived from bisphenol S 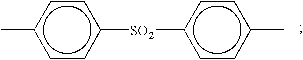
(e) a radical derived from hydrogenated bisphenol A 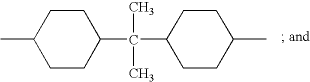
(f) a radical derived from a halo compound 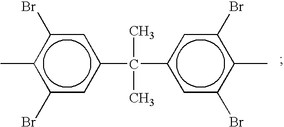
glycidyl amines: 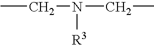
wherein R³ is C₁₋₆ alkyl;
(3) glycidyl ester: 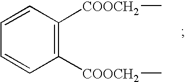
(4) glycerol: 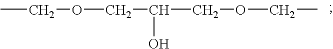
(5) ethylene glycol:
—CH₂—O—CH₂—CH₂—O—CH₂—;
(6) organic silicon: 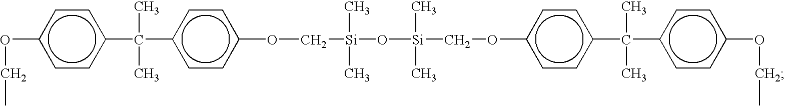
(7) alicyclic: 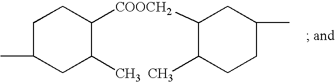
(8) imide epoxy resins: 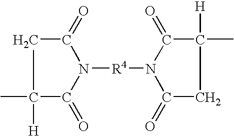
wherein R⁴ is aryl.

2. The polymer according to claim 1, wherein n is an integer of 1 to 300 and R¹ and R² are independently hydrogen, C₁₋₆ alkyl, C₁₋₆ alkoxy, or halogen.

3. The polymer according to claim 1, wherein R¹ is selected from the group consisting of ortho-methyl, meta-ethyl, para-methoxy, and para-chloro, and R² is selected from the group consisting of hydrogen, ortho-methyl, meta-ethyl, para-methoxy, and para-chloro.

4. The polymer according to claim 1, wherein R⁵ is hydrogen.

5. The polymer according to claim 1, having an average molecular weight of 5,000 to 200,000 and a branching level of 40% to 100%.

6. A process for preparing the polymer of claim 1, comprising steps of:
(A) conducting a condensation polymerization of an epoxy resin monomer and an aniline monomer to produce a hydroxy-containing pre-polymer, wherein the. epoxy resin monomer is selected from the group consisting of:
(1) glycidyl ethers: 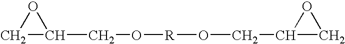
wherein R is selected from the group consisting of:
(a) a radical derived from hydroquinone: 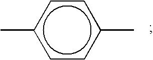
(e) a radical derived from diphenol: 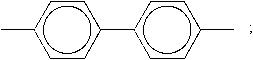
(e) a radical derived from bisphenol F 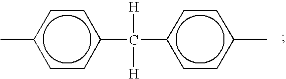
(e) a radical derived from bisphenol S 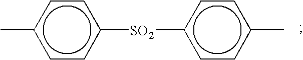
(e) a radical derived from hydrogenated bisphenol A: 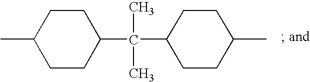
(f) a radical derived from a halo compound: 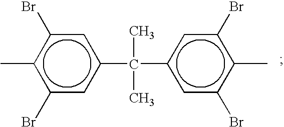
(2) glycidyl amines: 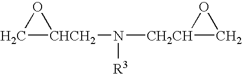
wherein R³ is defined as hereinabove;
(3) glycidyl ester: 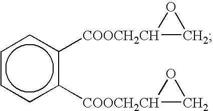
(4) glycerol: 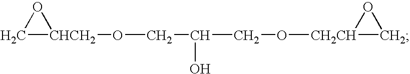
(5) ethylene glycol: 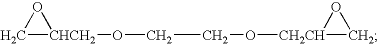
(6) organic silicon: 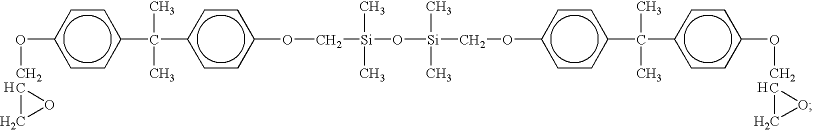
(7) alicyclic: 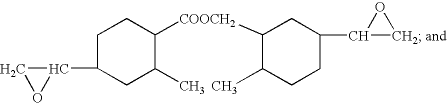
(8) imide epoxy resin: 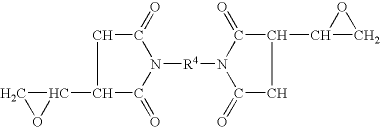
wherein R⁴ is defined as hereinabove; and
wherein the aniline monomer is selected from the compounds of formula (II): 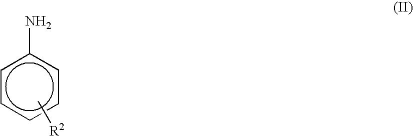
wherein R² is hydrogen, halogen, nitro, C¹⁻¹⁶ alkyl, or C₁₋₁₆ alkoxy, and is at the ortho-, meta-, or para-position of the benzene ring; and
(B) adding a chalcone acyl halide monomer, a solvent, and optional an acid absorber to the pre-polymer obtained in step (A) to obtain the polymer of formula (I), wherein said chalcone acyl halide monomer is selected from the compounds of formula (III): 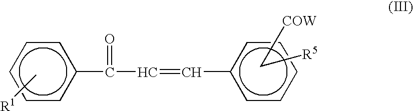
wherein R¹ is hydrogen, halogen, nitro, C₁₋₁₆ alkyl, or C₁₋₁₆ alkoxy; R⁵ is hydrogen, C₁₋₁₀ alkyl, or C₁₋₁₀ alkoxy; W is halogen; and R¹, R⁵, and COW are at the ortho-, meta-, or para-position of the benzene rings.

7. The process of claim 6, wherein said aniline monomer is selected from the group consisting of aniline, ortho-methylaniline, meta-ethylaniline, para-methoxyaniline, and para-chloroaniline, and said chalcone acyl halide monomer is selected from the group consisting of chalcone acyl chloride, ortho-methyl chalcone acyl chloride, meta-ethyl chalcone acyl chloride, para-methoxy chalcone acyl chloride, and para-chlorochalcone acyl chloride.

8. The process of claim 6, wherein said solvent is an aprotic polar solvent.

9. The process of claim 6, wherein said acid absorber is selected from the group consisting of pyridine, triethylamine, N-ethylmorpholine, and dimethylaniline, and a mixture thereof.

10. A liquid crystal alignment layer material containing the polymer of claim 1.
